(19) United States
(12) Patent Application Publication
(10) Pub. No.: US 2003/0114335 A1
(43) Pub. Date: Jun. 19, 2003

(54) Blend of imidazolinium quat and dialkyl dimethyl quat for use in high-solids fabric softeners with premium softening and viscosity properties

(75) Inventor: Jen Farn Liew, Toa Payoh (SG)

Correspondence Address: SCULLY SCOTT MURPHY & PRESSER, PC, 400 GARDEN CITY PLAZA, GARDEN CITY, NY, 11530

(73) Assignee: GOLDSCHMIDT CHEMICAL COMPANY, HOPEWELL, VA

(21) Appl. No.: 10/015,059

(22) Filed: Dec. 11, 2001

(51) Int. Cl. C11D 3/00; D06L 1/00; D06M 10/00

(52) U.S. Cl. 510/329; 510/330; 510/391; 510/504; 510/515

(57) ABSTRACT

A high-solids rinse cycle fabric softener formulation having enhanced viscosity and softening properties includes a blend of at least one imidazolinium quaternary ammonium compound, at least one dialkyl dimethyl quaternary ammonium compound and at least one solvent with the proviso that no thickening agents are utilized to achieve the enhanced viscosity properties. The formulation upon dilution increases in viscosity to a commercially successful level. The blend results in a combination of both hard and soft tallows for improved rewet and softening capabilities.

### FIELD OF THE INVENTION

The present invention relates to fabric softeners, and more particularly to a high-solids rinse cycle fabric softener formulation having enhanced viscosity and softening properties. Specifically, the present invention relates to a low-viscosity, high-solids rinse cycle fabric softener formulation which includes a blend of at least one imidazolinium quaternary ammonium compound, at least one dialkyl dimethyl quaternary ammonium compound and at least one solvent, with the proviso that no thickening agents are utilized to achieve the enhanced viscosity properties.

### BACKGROUND OF THE INVENTION

In the field of laundering, it is well known to add a liquid fabric softener containing at least one softening agent, such as a cationic quaternary ammonium compound or salt thereof, directly into the laundering process. The addition of the liquid fabric softener typically occurs during the rinse cycle itself.

Rinse cycle fabric softeners are provided in two forms: concentrated (i.e., high-solids) compositions containing more than 10% by weight of fabric softener agents, and diluted (i.e., low-solids) compositions containing 10% by weight or less of fabric softener agents. Consumer acceptance of rinse cycle fabric softeners is determined not only by the performance achieved with these products, but also by the aesthetics associated therewith. For example, environmentally conscious consumers tend to gravitate toward dilutable compositions because lesser packaging is more beneficial to the environment. However, high-viscosity fabric softeners (having a viscosity on the order of 400 cps (i.e., 0.4 Pas) or higher) are perceived by many consumers to be superior to low-viscosity fabric softeners. Viscosity of the rinse cycle fabric softener is therefore an important aspect of the successful formulation of such commercial products.

U.S. Pat. No. 3,625,891 is directed to high-solids fabric softening compositions lacking the addition of fillers. However, these fabric softening compositions fail as such compositions are not of high-viscosity at diluted levels.

Many low-solids fabric softeners, such as those disclosed in U.S. Pat. No. 4,233,167, add polymeric thickening agents such as polyacrylamides, polysaccharides and polyurethanes to the fabric softener formulation in an attempt to increase the viscosity of the formulation to a consumer desirable range. However, large quantities of these thickening agents are typically required in order to provide effective thickening of low-viscosity fabric softeners. While the use of such high quantities of thickening agents would provide a solution to the viscosity problem, this solution leads to an increased cost in formulating the fabric softener. Such cost is passed along to the consumer. This undesirable increased formulation costs further compound the problem in that conventional polymeric thickening agents provide no additional benefits to the fabric softener formulation and decrease the content of the active ingredients. Thus, additional ingredients besides thickening agents which further enhance the formulation performance are typically required.

Also compounding the problem is the fact that such filler-intensive fabric softeners may not be effectively produced in concentrated formulations. Thus, even for an environmentally conscious consumer, the concentration would not be desirable because the highly increased viscosity would make such a material extremely difficult to pour.

Quaternary ammonium compounds are cationic organic nitrogen-containing compounds of the general formula: R₄N⁺X⁻ wherein each R may be the same or different organic group, such as a hydrocarbon, which may also contain additional functionality and heteroatoms. Due to their physical properties, “quats”, as they are more commonly referred to, have found a variety of industrial uses from surfactants to germicides, organoclays to conditioning solutions.

In view of the drawbacks with the prior art mentioned above, it would be beneficial to provide a new and cost effective means for improving the viscosity of high-solids rinse cycle fabric softeners which do not require the use of conventional polymeric thickeners. Preferably, such a material would retain pourable or low-viscosity properties in the concentrated formulation, and would transform to a higher viscosity in the diluted formulation for consumer acceptance.

### SUMMARY OF THE INVENTION

The present invention relates to a low-viscosity, high-solids rinse cycle fabric softener formulation having enhanced viscosity and softening properties. The enhancement is achieved in the present invention by providing a blend of at least one imidazolinium quaternary ammonium compound and at least one dialkyl dimethyl quaternary ammonium compound in conjunction with at least one solvent or solvent system, with the proviso that no polymeric thickening agents are present, yet said formulation is capable of increased viscosity upon dilution with water.

The term “high-viscosity” fabric softener is used herein to denote a fabric softener having a viscosity on the order of about 400 cps (0.4 Pas) or greater, whereas the term “low-viscosity” fabric softener denotes a fabric softener having a viscosity of below about 400 cps (0.4 Pas).

The term “high-solids” fabric softener denotes a fabric softener formulation in which the fabric softening compound, i.e., the quaternary ammonium compound, is present in an amount of greater than 10% by weight, whereas the term “low-solids” denotes a fabric softener formulation in which the fabric softener component is present in an amount of about 10% by weight or less, preferably, about 1 to about 10% by weight, and even more preferably, about 2 to about 5% by weight.

In accordance with another aspect of the present invention, a method of preparing the above mentioned low-viscosity, high-solids rinse cycle fabric softener formulation is provided. Specifically, the inventive method comprises blending from about 1 to about 50% by weight of at least one imidazolinium quaternary ammonium compound with from about 1 about 40% by weight of at least one dialkyl dimethyl quaternary ammonium compound and about 1 to about 50% by weight of at least one solvent, wherein said formulation increases in viscosity upon dilution with water. The increased viscosity is achieved without the need of adding a conventional thickening agent to the formulation.

### DETAILED DESCRIPTION OF THE INVENTION

As stated above, the present invention relates to a low-viscosity, high-solids rinse cycle fabric softener formulation comprising a substantially homogeneous blend of (a) about 1 to about 50% by weight of at least one imidazolinium quaternary ammonium compound; (b) about 1 to about 40% by weight of at least one dialkyl dimethyl quaternary ammonium compound; and (c) about 1 to about 50% by weight of at least one solvent or solvent system, with the proviso that no polymeric thickening agents are present, yet said formulation is capable of increased viscosity upon dilution with water.

The term “imidazolinium quaternary ammonium compound” is used herein to denote a quaternary ammonium compound having the following formula:

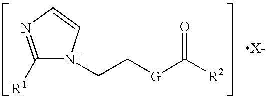

wherein R¹ is an saturated or unsaturated C₁₁₋₂₁ alkyl; R² is a divalent C₁₋₆ alkyl group; and G is oxygen or NH. Anion X is a halogen, such as chloride and bromide; an alkylsulfate, such as methyl sulfate and ethylsulfate; formate; acetate; carbonate; sulfate; nitrate and other like anions. Preferred anions include chloride and methyl sulfate. Examples of imidazolinium quats or imidazolinium quat blends that can be employed in the present invention include, but are not limited to: Rewoteric® 472 ET 80, Varisoft® 475, Rewoquat® W90, Rewoquat® W75, Rewoquat® W3690 and Varisoft® 3690, or the like. Note that Varisoft® 475, Rewoquat® W90 and Rewoquat® W75 are tradenames for methyl-1-tallow amidoethyl 2-tallow imidazolinium methyl sulfate, whereas Rewoquat® W3690 and Varisoft® 3690 are tradenames for the quat, methyl-1-oleyl amidoethyl 2-oleyl imidazolinium methyl sulfate.

The term “dialkyl dimethyl quaternary ammonium compound” is used herein to denote a quaternary ammonium compound having the following formula:

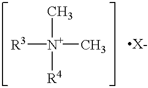

wherein R³ and R⁴ are the same or different and are each a C₁₋₁₈ alkyl; and X is one of the above mentioned anions. Preferably R³ and R⁴ are both C₁₄-C₁₈ alkyls. Examples of dialkyl dimethyl quats that can be employed in the present invention include, but are not limited to: di(hydrogentated tallow)alkyldimethyl ammonium chloride, Varisoft® 137 (dihydrogenated tallow dimethyl ammonium methyl sulfate), Adogen® 442 (dihydrogenated tallow dimethyl ammonium chloride) and Arosurf® TA 100 (distearyl dimethyl ammonium chloride).

The terms “solvent” or “solvent system”, or like terminology, are used herein to denote a solution utilized to improve water absorbancy of the present inventive formulation. Suitable solvents include, but are not limited to: ethanol, isopropyl alcohol, propylene glycol, dipropylene glycol, hexylene glycol, diethyl phthalate, and any combination thereof. Combinations of solvents, i.e., solvent systems, result in assorted preferable properties such as concentrate pourability, ease of dilution, viscosity after dilution and odor. One such preferred blend of solvents is diproplyene glycol (DPG) and diethyl phthalate (DEP) having a ratio of from about 9:1 to about 1:9. More preferably the ratio of DPG:DEP is 3:1.

In accordance with the present invention, the inventive high-viscosity, high-solids rinse cycle fabric softener formulation includes from about 1 to about 50% by weight of at least one imidazolinium quat; from about 1 to about 40% by weight of said at least one dialkyl dimethyl quat; and from about 1 to about 50% by weight of said solvent. Preferably, the inventive formulation includes from about 20 to about 40% by weight of at least one imidazolinium quat; from about 10 to about 30% by weight of said at least one dialkyl dimethyl quat; and from about 10 to about 30% by weight of said solvent. Most preferably, the inventive formulation includes from about 25 to about 35% by weight of at least one imidazolinium quat; from about 15 to about 25% by weight of said at least one dialkyl dimethyl quat; and from about 15 to about 25% by weight of said solvent.

Preferably, the present invention further includes deionized water wherein the ratio of quats:solvent:water is about 2:1:1.

The inventive formulation may include a variety of additional optional components such as perfumes, coloring agents, and antifoaming agents such as Tego® antifoam 1488 (10%), produced by Goldschmidt AG; and silicone antifoam emulsion (10%).

A method of preparing a low-viscosity, high-solids rinse cycle fabric softener formulation is also provided comprising blending about 1 to about 50% by weight of at least one imidazolinium quaternary ammonium compound; about 1 to about 40% by weight of at least one dialkyl dimethyl quaternary ammonium compound; and about 1 to about 50% by weight of at least one solvent, with the proviso that no polymeric thickening agent is present, yet said formulation is capable of increased viscosity upon dilution with water. Preferably the blend results in both hard and soft tallows.

The inventive high-viscosity, high-solids rinse cycle fabric softener is formed by blending at least one imidazolinium quat and dialkyl dimethyl quat in the presence of a solvent at a temperature of from about 50° to about 80° C., preferably from about 60° to about 70° C. Continuous stirring, may or may not, be carried out throughout the blending period.

When the composition comprises Rewoteric® 472 ET 80, dipropylene glycol (DPG) and diethyl phthalate (DEP), the composition is formulated by heating the Rewoteric® 472 ET 80 to a temperature under which the composition becomes clear. Typically, this occurs at a temperature of from about 35° to about 40° C. After the composition is heated, the other ingredients may be blended in and stirred until substantially homogeneous. If the product is too viscous, a small amount of ethanol or other like alcohol may be added. If the viscosity is too low, preferably small amounts of deionized water may be added to swell the solvents.

It has been found that by employing the above blending conditions, it is possible to form a high-solids rinse cycle fabric softener concentration which is a suspension at room temperature having a viscosity of about 100-200 cps (0.1-0.2 Pas) or lower. Thus, at approximately 15° C. or below, the product becomes a paste and thus should be stored above that temperature or be heated to room temperature before use. Furthermore, because the product is a suspension and therefore capable of separation on standing, the product should be shaken before dilution. However, it is noted that the increased viscosity is achieved in the present invention without the aid of a polymeric thickening agent.

The concentration may be diluted to reach a variety of different viscosities in accordance with Table 1 below. As will be noted below, the inventive product at high concentration is of low-viscosity (100-200 cps (0.1-0.2 Pas)) because of the presence of the solvent in the formulation. As this product is diluted with water, the solvent effect is reduced, causing the product to “swell” and become thick naturally. The viscosity is optimum for commercial success without the addition of any thickening additives or fillers. Thus, the inventive product is of low-viscosity in concentrated forms so that the product is pourable and yet the product is of a high viscosity upon dilution so that the appearance will be pleasing to consumers. The product is designed to be diluted in the range of about 6× to about 10×. Preferably the product is diluted to approximately 8× dilution factor.

TABLE 1
Dilution Factors

| Dilution Factor | Viscosity |
|---|---|
| 6x | 2000 cps (2 Pas) |
| 7x | 1000 cps (1 Pas) |
| 8x | 400 cps (0.4 Pas) |
| 9x | 150 cps (0.15 Pas) |
| 10x | 60 cps (0.06 Pas) |

In addition to having a high-viscosity associated therewith, the inventive high-solids rinse cycle fabric softener composition has enhanced softening and non-yellowing properties associated therewith.

The low-viscosity, high-solids rinse cycle fabric softener formulation of the present invention can be diluted and added during the rinse cycle of a laundering process wherein any detergent is present in the laundry liquor. That is, the inventive low-viscosity, high-solids rinse cycle fabric softener formulation can be added to a laundering liquor that contains anionic surfactants, non-ionic surfactants, amphoteric surfactants, zwitterionic surfactants or any combinations or mixtures thereof.

Suitable anionic surfactants that can be employed in the detergent composition include water soluble salts, preferably the alkali metal, ammonium and alkylammonium salts of organic sulfuric acid reaction products having in their molecular structure an alkyl group containing from about 10 to about 20 carbon atoms and a sulfonic acid or sulfuric acid ester group. (Included in the term “alkyl” is the alkyl portions of acyl groups).

Some illustrative examples of the above type of anionic surfactants are the sodium and potassium alkyl sulfates, especially those obtained by sulfating higher C₈₋₁₈ alcohols, such as those produced by reducing the glycerides of tallow or coconut oil; and the sodium and potassium alkylbenzene sulfonates in which the alkyl group is straight chained or branched, and the alkyl contains from about 9 to about 15 carbon atoms. The alkylbenzene sulfonates of the former type are described, for example, in U.S. Pat. Nos. 2,220,099 and 2,477,383, the contents of each reference is incorporated herein by reference.

Especially preferred alkylbenzene sulfonates are linear straight chain alkylbenzene sulfonates in which the average number of carbon atoms in the alkyl group is from about 10 to 15, abbreviated as C₁₀₋₁₅ LAS. The alkali salts, particularly the sodium salts of these anionic surfactants are preferred. Alkylbenzene sulfonates and processes for producing the same are disclosed, for example, in U.S. Pat. Nos. 2,220,099 and 2,477,383.

Other anionic surfactants that can be employed in the detergent composition include alkyl alkoxylated sulfates. These compounds are water-soluble salts or acids having the formula R⁶O(E)ₘSO₃M wherein R⁶ is an unsubstituted C₁₀₋₂₄ alkyl or hydroxyalkyl group having a C₁₀₋₁₈ alkyl or hydroxyalkyl group; E is an ethoxy or propoxy unit; m is greater than zero, preferably m is between about 0.5 and about 6; and M is hydrogen or a water soluble cation which can be, for example, a metal cation (e.g., sodium, potassium, lithium, calcium, magnesium, etc.), ammonium or substituted-ammonium cation. Specific examples of substituted ammonium cations include, but are not limited to: methyl-, ethyl-, dimethyl-, trimethyl-ammonium and quaternary ammonium cations, such as tetramethyl-ammonium, dimethyl piperdinum and cations derived from alkanolamines such as monoethanolamine, diethanolamine and triethlamine, and mixtures thereof.

Illustrative examples of the foregoing alkyl alkoxylated sulfates include: C₁₂₋₁₈ alkyl polyethoxylate (1.0) sulfate, C₁₂₋₁₈ alkyl polyethoxylate (2.25) sulfate, C₁₂₋₁₈ alkyl polyethoxylate (3.0) sulfate, C₁₂₋₁₈ alkyl polyethoxylate (4.0) sulfate, wherein M is sodium or potassium.

Other anionic surfactants useful in the detergent composition include sodium alkyl glyceryl ether sulfonates, particularly those ethers of higher alcohols derived from tallow and coconut oil; sodium coconut oil fatty acid monoglyceride sulfonates and sulfates.

Still further anionic surfactants include water-soluble salts of esters of alpha-sulfonated fatty acids containing from about 6 to about 20 carbon atoms in the fatty acid portion of the compound and from 1 to about 10 carbon atoms in the ester group; water-soluble salts of 2-acyloxyalkane-1-sulfonic acids containing from about 2 to about 9 carbon atoms in the acyl portion of the compound and from about 9 to about 23 carbon atoms in the alkane moiety; water-soluble salts of olefin and paraffin sulfonates containing from about 12 to about 20 carbon atoms; and beta-alkyloxy alkane sulfonates containing from 1 to about 3 carbon atoms in the alkyl group and from about 8 to about 20 carbon atoms in the alkane moiety.

Typical nonionic surfactants that can be present in the detergent composition include polyethylene, polypropylene and polybutylene oxide condensates of alkyl phenols. Other examples of nonionic surfactants include: condensation products of primary and secondary aliphatic alcohols, alkylpolysaccharides, condensation products of ethylene oxide with a hydrophobic base formed by the condensation of propylene oxide with propylene glycol, condensation products of ethylene oxide with the product resulting from the reaction of propylene oxide and ethylenediamine, and polyhydroxy fatty acid amides.

The detergent may also include any conventional amphoteric or zwitterionic surfactant therein. The use of the inventive high-viscosity, high-solids rinse cycle fabric softener formulation is not limited to a specific type of detergent, but rather the rinse cycle fabric softener formulation of the present invention can be used with any conventional detergent.

In addition to the above ingredients, the detergent composition may also include conventional detergent builders, enzymes, bleaching agents, bleach activators, polymeric soil release agents, chelating agents, soil release and anti-redeposition agents, dispersing agents, optical brighteners, whitening agents, betaines, sultanies and other like components that may be typically used in laundry detergents. Since all these compounds are conventional, a detailed description of the optional components is not provided herein. A detailed description of these detergent components however can be found in WO 98/53034, the contents of which is incorporated herein by reference.

The low-viscosity, high-solids rinse cycle fabric softener formulation of the present invention is typically diluted and added to the rinse cycle of a laundry process utilizing conventional washing temperatures of about 20° to about 70° C. and rinsing temperatures of about 10° to about 50° C. The rinse cycle fabric softener formulation of the present invention is effective over a wide range of water hardness levels.

The rinse cycle fabric softener of the present invention may be used in laundering operations by adding the formulation to a laundering vessel in amounts that are typically used. The low-viscosity, high-solids rinse cycle fabric softener formulation of the present invention is used in the rinse cycle of any laundering process wherein conventional detergents are employed. Specifically, the inventive rinse cycle formulation of the present invention is used in an amount of from about 0.1 to about 0.3 weight % of said fabric softener formulation, per 100 grams of fabric to be laundered. The particular amount of fabric softener used in the rinsing cycle is not however critical to the present invention.

The following examples are given to illustrate the present invention and to demonstrate some advantages that can be obtained from utilizing the same.

### EXAMPLE 1

### Comparison of Solvents and Blends

Assorted solvent solutions and combinations were tested with the present invention for concentrate pourability, ease of dilution, viscosity after dilution and odor. The solvents tested are shown in the table below wherein “√” denotes the solvent achieves the listed objective and “X” denotes the solvent did not under testing achieve the listed objective.

TABLE 2
Comparison of Solvents

| | Concentrate | Ease of | Viscosity | |
|---|---|---|---|---|
| Solvent | Pourability | Dilution | after Dilution | Odor |
| Ethanol | ✓ | ✓ | ✓ | X |
| IPA | ✓ | ✓ | ✓ | X |
| Propylene Glycol | X | X | ✓ | ✓ |
| Hexylene Glycol | ✓ | ✓ | ✓ | X |
| Dipropylene Glycol | X | X | ✓ | ✓ |
| (DPG) | | | | |
| Diethyl Phthalate | ✓ | ✓ | X | ✓ |
| (DEP) | | | | |
| DPG/DEP Blend | ✓ | ✓ | ✓ | ✓ |

As shown above, a blend of DPG/DEP achieves all preferably characteristics in a single solvent blend when utilized in the inventive formulation.

### EXAMPLE 2

### Sample Formulation

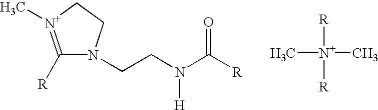

In this example, an inventive low-viscosity, high-solids rinse cycle fabric softener formulation was prepared in accordance with the present invention and was compared to fabric softener formulations of the prior art which included Rewoteric® 472 ET 80. The R groups being tallow, (i.e., 60-70% by weight imidazolinium compound and 30-40% by weight dialkyl dimethyl quat compound) alone having 80% solids and a viscosity of about 200 cps (0.2 Pas) (spindle #3 60 rpm). The inventive blend comprised 50% by weight Rewoteric®472 ET 80 (a combination of Varisoft ® 475 and Varisoft® 137) and 25% by weight of a solvent solution (comprising 70% dipropylene glycol and 25% diethyl phthalate) wherein the blend had a 25% deionized water content, 3% perfume content and 2% Tego®antifoam 1488 and a viscosity of 100-200 cps (0.1-0.2 Pas) associated therewith. All viscosities reported herein were made at 23° C. using a Brookfield spindle #3 at 30 rpm.

### EXAMPLE 3

### Softening Performance

Softening performance of the inventive blend, as prepared via the methods of Example 2, was compared to that of Rewoteric® 472 ET 80 alone using the following conditions:

Water Temperature=25° C.

Fabric=4 cotton towels (˜240 g), sheets (˜1.3 kg)

Water Volume=43 L

Water/Fabric Ratio=25/1

Water Type=tap water

Softener Dosage=15% based on dry fabric weight

Detergent Dosage=none

Drying=line

The program setting was as follows: Economy process with Rinse and Spin wherein the water power was set at normal. The water lever was listed as small. The washing machine was started to allow the water to flow in. Once the water level was about half way the softener dispersion was added. The towels and sheets were added just before the rinse cycle stated. When the rinse and spin cycles were finished, the fabrics were removed and air dried overnight for analysis.

Using the above conditions, it was determined by a panel of four that the inventive blend felt no different that the regular Rewoteric® 472 ET 80 alone.

### EXAMPLE 4

### Rewet Performance

The rewet performance of the inventive formulation of Example 2 was compared against the rewet performance of regular Rewoteric® 472 ET 80. A rewet test apparatus was set up wherein the ruler was horizontally attached to the retort stands. 1″×6″ swatches from the towels of Example 3 were prepared to be tested for water absorbancy. A 1 cm line was marked from the bottom of the narrow edge of each swatch. Thus, the swatches were attached on to the ruler with a clothes peg while ensuring that the base was horizontal. A tray was then filled with dye solution. A stopwatch was started when the tray was raised to the level of the 1 cm mark near the bottom edge of the swatches. The distance of migration was marked with a permanent marker after 1, 5, and 10 minutes. Each test was repeated 3 times for accuracy and the readings were averaged. An untreated towel swatch was used as a control. The results at 10 minutes are shown in Table 3 below.

TABLE 3
Rewet Performance

| Formulation | Softening Rating | Rewet |
|---|---|---|
| Regular Rewoteric ® 472 ET 80 | 0.63 | 74% |
| Inventive Formulation including | 0.63 | 83% |
| Rewoteric ® 472 ET 80 | | |

As is shown above, the inventive formulation of the present invention, which includes Rewoteric® 472 ET 80 and a solvent blend of DPG/DEP (75%:25%), is suitable for a dilutable concentrate. The formulation developed is a low viscosity, pourable suspension which, when diluted 8×, achieves a viscosity of 400 cps (0.4 Pa·s). The inventive formulation has low odor and has excellent softening and rewetting properties.

While the present invention has been particularly shown and described with respect to preferred embodiments thereof, it will be understood by those skilled in the art that the foregoing and other changes in form and detail may be made without departing from the spirit and scope of the present invention. It is therefore intended that the present invention not be limited to the exact forms described and illustrated, but fall within the scope of the appended claims.

Having thus described my invention in detail, what I claim as new and desire to secure by the Letters Patent is:

1. A low-viscosity, high-solids rinse cycle fabric softener formulation comprising a blend of (a) about 1 to about 50% by weight of at least one imidazolinium quaternary ammonium compound; (b) about 1 to about 40% by weight of at least one dialkyl dimethyl quaternary ammonium compound; and (c) about 1 to about 50% by weight of at least one solvent, with the proviso that no polymeric thickening agent is present.

2. The fabric softener formulation of claim 1 wherein the at least one imidazolinium quaternary ammonium compound is present in an amount of from about 20 to about 40% by weight.

3. The fabric softener formulation of claim 2 wherein the at least one imidazolinium quaternary ammonium compound is present in an amount of from about 25 to about 35% by weight.

4. The fabric softener formulation of claim 1 wherein said at least one imidazolinium quaternary ammonium compound has the following structural formula: 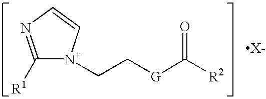
wherein:
X is an anion;
R¹ is a saturated or unsaturated C₁₁₋₂₁ alkyl;
R² is a divalent C₁₋₆ alkyl group; and
G is oxygen or NH.

5. The fabric softener formulation of claim 4 wherein the at least one imidazolinium quaternary ammonium compound is methyl 1-tallow amidoethyl 2-tallow imidazolinium methyl sulfate.

6. The fabric softener formulation of claim 4 wherein the at least one imidazolinium quaternary ammonium compound is methyl 1-oleyl amidoethyl 2-oleyl imidazolinium methyl sulfate.

7. The fabric softener formulation of claim 1 wherein the at least one dialkyl dimethyl quaternary ammonium compound is present in an amount of from about 10 to about 30% by weight.

8. The fabric softener formulation of claim 7 wherein the at least one dialkyl dimethyl quaternary ammonium compound is present in an amount of from about 15 to about 25% by weight.

9. The fabric softener formulation of claim 1 wherein the at least one dialkyl dimethyl quaternary ammonium compound has the following structural formula: 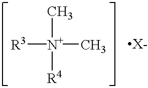
wherein:
X is an anion; and
R³ and R⁴ are the same or different C₁₋₁₈ alkyl.

10. The fabric softener formulation of claim 9 wherein R³ and R⁴ are both C₁₄-C₁₈ alkyls.

11. The fabric softener formulation of claim 9 wherein said at least one dialkyl dimethyl quaternary ammonium compound is di(hydrogenated tallow)alkyldimethyl ammonium chloride.

12. The fabric softener formulation of claim 9 wherein said at least one dialkyl dimethyl quaternary ammonium compound is dehydrogenated tallow dimethyl ammonium methyl sulfate, or distearyl dimethyl ammonium chloride.

13. The fabric softener formulation of claim 1 wherein the at least one solvent is present in an amount of from about 10 to about 30% by weight.

14. The fabric softener formulation of claim 13 wherein the at least one solvent is present in an amount of from about 10 to about 25% by weight.

15. The fabric softener formulation of claim 1 wherein the at least one solvent is a solvent system comprising dipropylene glycol (DPG) and diethyl phthalate (DEP).

16. The fabric softener formulation of claim 15 wherein the ratio of DPG:DEP is from about 9:1 to about 1:9.

17. The fabric softener formulation of claim 16 wherein the ratio of DPG:DEP is 3:1.

18. The fabric softener formulation of claim 1 further comprising deionized water.

19. The fabric softener formulation of claim 18 wherein the ratio of quats:solvent:water is about 2:1:1.

20. The fabric softener formulation of claim 1 wherein the blend results in both hard and soft tallows.

21. A method of preparing a low-viscosity, high-solids rinse cycle fabric softener formulation comprising blending about 1 to about 50% by weight of at least one imidazolinium quaternary ammonium compound; about 1 to about 40% by weight of at least one dialkyl dimethyl quaternary ammonium compound; and about 1 to about 50% by weight of at least one solvent, with the proviso that no polymeric thickening agent is present; said formulation capable of increased viscosity upon dilution with water.

22. The method of claim 21 wherein the fabric softener formulation is blended at a temperature of from about 50° to about 80° C.

23. The method of claim 22 wherein the fabric softener formulation is blended at a temperature of from about 60° to about 70° C.

24. The method of claim 21 wherein the at least one imidazolinium quaternary ammonium compound is present in an amount of from about 20 to about 40% by weight.

25. The method of claim 24 wherein the at least one imidazolinium quaternary ammonium compound is present in an amount of from about 25 to about 35% by weight.

26. The method of claim 21 wherein said at least one imidazolinium quaternary ammonium compound has the following structural formula: 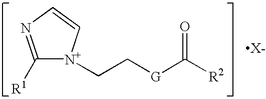
wherein:
X is an anion;
R¹ is a saturated or unsaturated C₁₁₋₂₁ alkyl;
R² is a divalent C₁₋₆ alkyl group; and
G is oxygen or NH.

27. The method of claim 21 wherein the at least one dialkyl dimethyl quaternary ammonium compound is present in an amount of from about 10 to about 30% by weight.

28. The method of claim 27 wherein the fabric softener formulation of claim 1 further comprising deionized water.

29. The method of claim 21 wherein the ratio of quats:solvent:water is about 2:1:1.

30. The method of claim 29 wherein R³ and R⁴ are both C₁₄-C₁₈ alkyls.

31. The method of claim 21 wherein the at least one solvent is present in an amount of from about 10 to about 30% by weight.

32. The method of claim 31 wherein the at least one solvent is present in an amount of from about 10 to about 25% by weight.

33. The method of claim 21 wherein the at least one solvent is a solvent system comprising dipropylene glycol (DPG) and diethyl phthalate (DEP).

34. A method of laundering comprising adding a low-viscosity, high-solids rinse cycle fabric softener formulation to an article needing laundering wherein the fabric softener formulation comprises a blend of about 1 to about 50% by weight of at least one imidazolinium quaternary ammonium compound; about 1 to about 40% by weight of at least one dialkyl dimethyl quaternary ammonium compound; and about 1 to about 50% by weight of at least one solvent, with the proviso that no polymeric thickening agent is present yet said formulation is capable of increased viscosity upon dilution with water.

35. The method of claim 34 wherein the blend is used in an amount of from about 0.1 to about 0.3 weight % of said fabric softener per 100 grams of fabric to be laundered.
